(19) United States
(12) Patent Application Publication
(10) Pub. No.: US 2022/0136595 A1
(43) Pub. Date: May 5, 2022

(54) DRIVE UNIT ASSEMBLY

(71) Applicant: Dana Heavy Vehicle Systems Group, LLC, Maumee, OH (US)

(72) Inventors: Saket V. Kale, Pune (IN); Vijay D. Kadam, Pune (IN); Rahul S. Shah, Pune (IN)

(73) Assignee: Dana Heavy Vehicle Systems Group, LLC, Maumee, OH (US)

(21) Appl. No.: 17/126,164

(22) Filed: Dec. 18, 2020

(30) Foreign Application Priority Data
Nov. 4, 2020 (IN) 202011048125

(51) Int. Cl. F16H 48/40; F16H 48/08

(52) U.S. Cl. CPC F16H 48/40; F16H 2048/385; F16H 48/08

(57) ABSTRACT

A drive unit assembly including a differential assembly. The differential assembly includes a ring gear including an annular flange portion having an inner face and a differential case having an inner face configured to cooperate with the inner face of the annular flange portion of the ring gear. The differential case is configured to receive a spider therein, wherein the spider includes a main body including center bore formed therein, and wherein the center bore is configured to receive at least one output shaft therethrough.

### CROSS-REFERENCE TO RELATED APPLICATION

The present application claims the benefit to Indian Patent Application No. 202011048125, filed Nov. 4, 2020, which is incorporated herein by reference in its entirety.

### FIELD

The present disclosure relates to a drive unit assembly, and more particularly, a drive unit assembly including a differential assembly having a hub-style ring gear with an integrated differential case flange.

### BACKGROUND

Conventional vehicles, such as passenger and commercial vehicles, have a forward mounted engine with an associated drive train extending from the engine to the rear axle. The rear axle traditionally is equipped with a drive unit assembly including a differential assembly which is adapted to transmit power from a drive shaft to the rear axles. Several other types of drive unit assemblies for transmitting power are well known in the art and are widely used in industrial applications other than in vehicles.

Problems have arisen in some hub-style gear drive unit applications. Most heavy duty trucks presently being manufactured with hub-style gear and non-split differential cases are adapted to be driven through a rear axle differential assembly. Prior art differential assemblies typically require three shaft pins in the hub-style gear drive unit to mount pinion gears and side washers within a differential case. The shaft pins require precise machining and tight tolerances since they are press fit or slidingly fitted into the differential case. Separate locking pins are also necessary to prevent rotation of the shaft pins. The locking pins are known to deform under a load, making disassembly of the differential for servicing difficult. The shaft pins also prevent axle shafts from passing therethrough, which necessitates axle shafts of different lengths for different gear ratios. Additionally, in some conventional differential assemblies, an outer diameter of the differential case requires precise machining since it mates with an inner diameter of the ring gear.

It would therefore be advantageous to develop a drive unit assembly including a differential assembly having a hub-style ring gear with an integrated differential case flange, which minimizes cost and complexity as precise machining can be avoided and use of parts produced from premium materials is minimized.

### SUMMARY

In concordance and agreement with the present disclosure, a drive unit assembly including a differential assembly having a hub-style ring gear with an integrated differential case flange, which minimizes cost and complexity as precise machining can be avoided and use of parts produced from premium materials is minimized, has surprisingly been discovered.

In one embodiment, a differential assembly, comprises: a ring gear including an annular flange portion having an inner face; a differential case configured to receive a spider therein, wherein an inner face of the differential case is configured to cooperate with the inner face of the annular flange portion of the ring gear to maintain a position of the spider.

As aspects of certain embodiments, a portion of the spider is clamped between the ring gear and the differential case.

As aspects of certain embodiments, the spider includes a generally ring-shaped main body having a center bore formed therein.

As aspects of certain embodiments, the spider includes at least one leg portion radially outwardly extending from the main body.

As aspects of certain embodiments, the ring gear and the differential case includes at least one generally semi-circular cross-bore formed therein.

As aspects of certain embodiments, a portion of the spider is received into a throughbore formed by the cross-bores formed in the ring gear and the cross-bore formed in the differential case.

As aspects of certain embodiments, the ring gear includes at least one axially extending bore formed therein.

As aspects of certain embodiments, the ring gear is affixed to the differential case by at least one fastener received in the at least one axially extending bore.

In another embodiments, a differential assembly, comprises: a ring gear including an annular flange portion having an inner face; a differential case having an inner face configured to cooperate with the inner face of the annular flange portion of the ring gear, the differential case configured to receive a spider therein, wherein the spider includes a main body including center bore formed therein, and wherein the center bore is configured to received at least one output shaft therethrough.

As aspects of certain embodiments, a portion of the spider is clamped between the ring gear and the differential case.

As aspects of certain embodiments, the spider includes at least one leg portion radially outwardly extending from the main body.

As aspects of certain embodiments, the ring gear and the differential case includes at least one generally semi-circular cross-bore formed therein.

As aspects of certain embodiments, a portion of the spider is received into a throughbore formed by the cross-bores formed in the ring gear and the cross-bore formed in the differential case.

As aspects of certain embodiments, the ring gear includes at least one axially extending bore formed therein.

As aspects of certain embodiments, the ring gear is affixed to the differential case by at least one fastener received in the at least one axially extending bore.

In yet another embodiments, a drive unit assembly for an axle, comprises: a differential assembly including a ring gear, a differential case configured to cooperate with the ring gear, and a differential gear assembly at least partially disposed in the differential case, wherein the differential gear assembly includes: a spider clamped between the ring gear and the differential case, the spider including a main body having a center bore and a plurality of radially outwardly extending leg portions, wherein the center bore is configured to receive a first axle shaft therethrough; and a plurality of gears disposed within the differential case, wherein at least one of the gears is disposed on at least one of the leg portions of the spider.

As aspects of certain embodiments, the differential assembly is configured to receive a second axle shaft.

As aspects of certain embodiments, a length of the first axle shaft is substantially equal to a length of the second axle shaft.

As aspects of certain embodiment, a length of the first axle shaft is different from a length of the second axle shaft.

The drive unit assembly including the differential assembly having the hub-style ring gear with the integrated differential case flange facilitates the use of the spider to be assembled in the differential assembly. The spider provides for axle shaft pass through. As such, the maintenance and repair of the axle shafts is improved (i.e. removal of drive heads is no longer necessary). The design of the drive unit assembly of the presently described subject matter facilitates the use of axle shafts of equal lengths on both sides of the axle for a majority of gear ratios with variable mounting distances. Accordingly, a poka yoke method to assemble the axle shafts is not required and a cycle time of assembly of the differential assembly is also improved.

Additionally, the drive unit assembly of the presently described subject matter does not require locking dowel pins for locking of shaft differential pins with the differential case to restrict its rotation as that in the conventional designs. Thus, there is a reduction in a number of parts in the presently described subject matter as compared to that of the conventional designs. Contrary to the conventional designs, with use of the presently described subject matter, precise machining of certain parts and parts produced from premium materials may be avoided.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 is a cross-sectional top view of a drive unit assembly including a differential assembly having a hub-style ring gear with an integrated differential case flange according to an embodiment of the disclosure;

FIG. 2 is a cross-sectional view of the differential assembly of the drive unit illustrated in FIG. 1;

FIG. 3 is an enlarged fragmentary perspective view of a portion of the differential assembly illustrated in FIGS. 1 and 2; and

FIG. 4 is an exploded view of the differential assembly illustrated in FIGS. 1, 2, and 3.

### DETAILED DESCRIPTION

It is to be understood that the invention may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

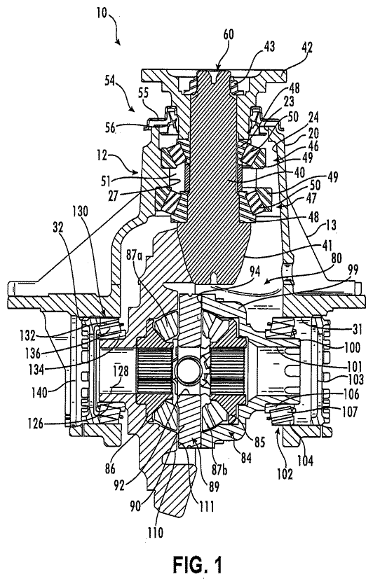

FIG. 1 shows a drive unit assembly 10 for an axle according to an embodiment of the presently disclosed subject matter. The drive unit assembly 10 comprises a housing 12 having a front portion or carrier 13 and a rear portion or banjo (not depicted). It is understood that the front portion 13 and the rear portion may be joined together by any suitable method as desired such as by mechanical fasteners, for example.

The front housing portion 13 includes a boss 20 through which is formed a bore 24 defining an input opening 23. The bore 24 may include an annular ridge 27 concentric with the bore 24. The housing 12 may further include two concentric cross bores 31, 32. A drive pinion gear 60, having a generally longitudinal axis about which it is rotatable, extends through the input opening 23 into the bore 24. The drive pinion gear 60 includes an input shaft 40 configured to receive a yoke 42 thereon. In one embodiment, the yoke 42 is rigidly affixed to an axially outer portion of the input shaft 40 by means of a nut 43. A gear head 41 having a plurality of gear teeth (not depicted) formed on an outer circumferential surface is coupled to an axially inner portion of the input shaft 40. It is understood that the gear head 41 may be a separate component or integrally formed with the input shaft 40 as desired.

An outer pinion bearing assembly 46 and an inner pinion bearing assembly 47 are positioned within the bore 24 on opposite sides of the ridge 27 for rotatably supporting the input shaft 40 of the drive pinion gear 60. A lubricant collection area 51 exists between the bearing assemblies 46, 47 for lubrication purposes. The pinion bearing assemblies 46, 47 each comprise an inner race 48 rotatable with the input shaft 40 and an outer race 49 rigidly affixed to the surface of the bore 24 and abuttingly associated with the ridge 27. The bearing assemblies 46, 47 each include a plurality of circumferentially spaced tapered roller bearings 50, each set of roller bearings 50 being tapered toward the other bearing assembly (i.e., the smallest diameter portion of each bearing is exposed to the collection area 51 between the bearing assemblies 46, 47). The outer pinion bearing assembly 46 is secured within the bore 24 by the yoke 42 which abuts the outer bearing assembly inner race 48 and is rotatable therewith. The inner bearing assembly 47 ultimately is held in position by the gear head 41 of the drive pinion gear 60.

The drive unit assembly 10 is protected from dirt or debris entering through the input opening 23 by means of a guard assembly 54 extending between the yoke 42 and the front housing boss 20. In certain embodiments, the guard assembly 54 comprises an annular cap 55 rigidly affixed to the rotatable yoke 42. An annular seal 56 may be secured within the input opening 23 for rotational sliding engagement with the cap 55.

A differential assembly 80 is positioned within the housing 12. The differential assembly 80 is configured to receive a first output shaft (not depicted), such as a right side axle half shaft, for example, and a second output shaft (not depicted), such as a left side axle half shaft, for example. In certain embodiments, the output shafts are rotatable within the differential assembly 80, and extend from within the side output openings 31, 32. The differential assembly 80 includes a differential gear assembly 84 disposed within a plain-half differential case 99 and a rotatable hub-style ring gear 108 coupled to the differential case 99. The differential gear assembly 84 includes a differential side gears 85, 86. Each of the differential side gears 85, 86 is rigidly affixed to one of an inwardly extending portion of a respective one of the output shafts. As shown, the side gears 85, 86 are coupled to the respective one of output shafts by a splined connection. It is understood, however, that the side gears 85, 86 may be coupled to the output shafts by any suitable method as desired.

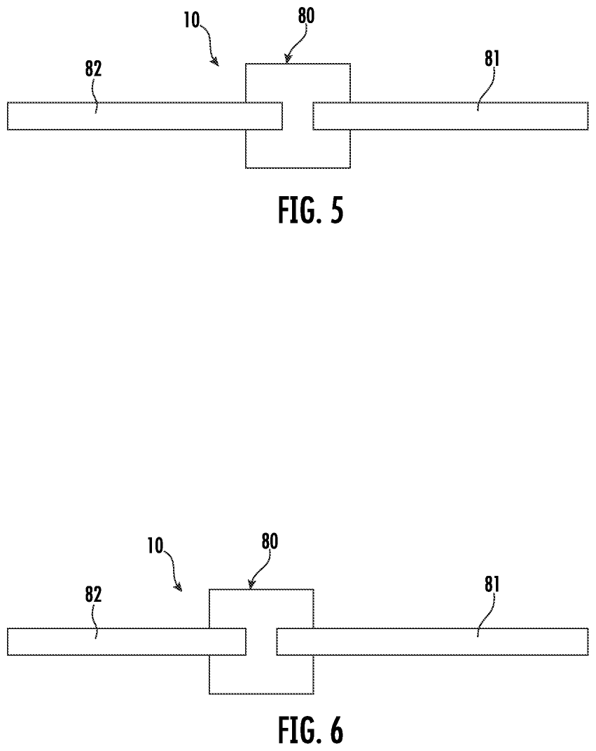

As illustrated in FIGS. 1, 2, and 4, each of the side gears 85, 86 is drivingly engaged with a plurality of bevel gears 87 of the differential gear assembly 84. In certain embodiments, each of the side gears 85, 86 is drivingly engaged with four bevel gears 87a, 87b, 87c, 87d, as more clearly shown in FIG. 4, which are rotatably supported by a differential spider 89 of the differential gear assembly 84. In other embodiments, the differential gear assembly 84 may further include any number of bevel gears 87 as desired.

In certain embodiments, the differential spider 89 includes a generally ring-shaped main body 91 having a central bore 92. The differential spider 89 may be formed by any suitable forming method such as by a forging process, for example. As such, the differential spider 89 may not require such tight manufacturing tolerances as a conventional differential ring-and-pin design. Hence, the differential spider 89 may have more strength and be less costly to manufacture than the conventional design. The central bore 92 may be configured, sized, and shaped to receive at least one of the outputs shafts therethrough. Accordingly, the output shafts may have equal or differing lengths, as desired. The differential spider 89 may further include at least one radially outwardly extending leg portion 90 from the main body 91. As illustrated in FIG. 4, the differential spider 89 includes four leg portions 90a, 90b, 90c, 90d radially outwardly extending therefrom. In other embodiments, the differential spider 89 may include either less than or more than four leg portions 90. The leg portions 90a, 90b, 90c, 90d may be disposed about a circumference of the main body 91. As shown, the leg portions 90 may be spaced apart along the circumference of the main body 91 by about 90 degrees. It is understood, however, that the leg portions 90 may be spaced apart and positioned around the circumference of the main body 91 in any configuration as desired. As seen in FIG. 1 and as a non-limiting example, each of the bevel gears 87 is mounted on each of the leg portions 90 of the spider 89. In some examples, the four bevel gears 87a, 87b, 87c, 87d are mounted on one of a respective one of the four leg portions 90a, 90b, 90c, 90d. A first thrust washer 92 may be disposed on each of the leg portions 90 radially outward from the bevel gear 87. As shown in FIG. 4, each of four first thrust washers 92a, 92b, 92c, 92d is disposed on one of a respective one of the four bevel gears 87a, 87b, 87c, 87d. In other embodiments, the differential gear assembly 84 may include any number of first thrust washers 92 as desired. A second washer 93, shown in FIG. 4, may be interposed between the side gear 85 and the differential case 99 to militate against excessive wear therebetween.

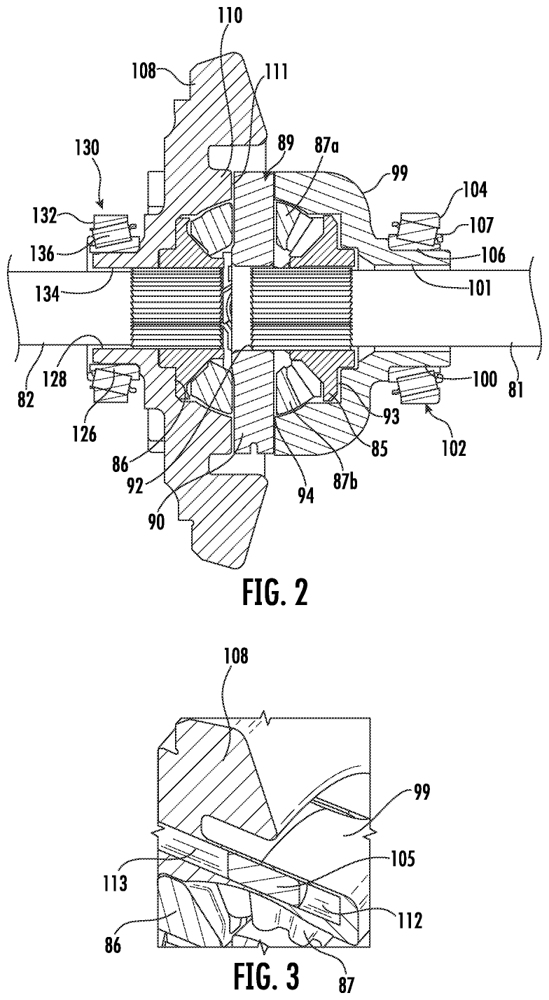

As more clearly shown in FIGS. 1 and 2, each of the leg portions 90 extends into throughbores 94 formed by the differential case 99 and the ring gear 108. The leg portions 90 are configured to be rotatably driven about a longitudinal axis of the axle in response to rotation of the differential case 99 as will hereinafter be described. The differential case 99 surrounds the differential gear assembly 84 and is rotatable around the longitudinal axis of the axle. The differential case 99 includes an axially extending hub 100 having a bore 101 through which one of the output shafts extends.

A first output bearing assembly 102 is operatively affixed within the output bore 31. The first output bearing assembly 102 includes an outer race 104 affixed to the housing 12 of the drive unit assembly 10, an inner race 106 affixed to and rotatable with the hub 100 of the differential case 99, and a set of circumferentially spaced roller bearings 107 tapered generally outwardly from the differential gear assembly 84, i.e., having the larger diameter end portions nearest the differential gear assembly 84. A locking member 103 may be disposed into the output bore 31 of the housing 12 to secure the first output bearing assembly 102 therein.

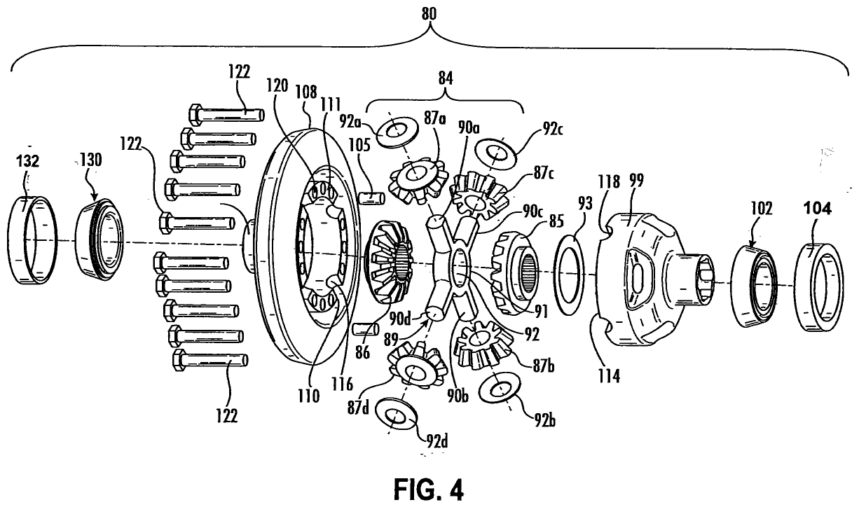

The differential case 99 is rigidly affixed to the ring gear 108. As more clearly shown in FIG. 3, the differential case 99 is rotatably positioned relative to the ring gear 108 by at least one positioning member 105 (e.g. a dowel pin). In certain embodiments, the positioning member 105 may be partially disposed in an aperture 112 formed in the differential case 99 and partially disposed in a corresponding aperture 113 formed in the ring gear 108, which is aligned with the aperture 112 of the differential case 99. Although the positioning members 105 shown are press-fit into the apertures 112, 113 of the differential case 99 and the ring gear 108, respectively, it is understood that the positioning members 105 may be secured in the differential assembly 80 by any suitable means as desired. The ring gear 108 includes a plurality of teeth (not depicted) which are in driving engagement with the teeth formed on the gear head 41 of the drive pinion gear 60.

A radially inner portion of the ring gear 108 includes an integrated differential case comprising an annular flange portion 110 having an inner face 111. The inner face 111 of the annular flange portion 110 abuts and mates with an inner face 114 of the differential case 99. Each of the inner face 111 of the annular flange portion 110 and the inner face 114 of the differential case 99 has at least one generally semi-circular cross-bore 116, 118, respectively, formed therein to extend radially from an inner circumferential surface of the ring gear 108 and the differential case 99 to an outer circumferential surface thereof. In certain embodiments, the cross-bores 116, 118 are in alignment to form the throughbores 94, each having a generally circular cross-sectional shape. An end of each of the leg portions 90 of the spider 89 is clamped between the ring gear 108 and the differential case 99 to secure and maintain a position of the spider 89 within the differential case 99. Thus, an assembly and disassembly of the spider 89 within the differential case 99 may be easier and less time consuming as compared to the conventional designs.

Advantageously, the annular flange portion 110 allows the differential gear assembly 84 to be disposed further into the ring gear 108 having the side gear 86 abut an inner face 119 of the ring gear 108.

In certain embodiments, the annular flange portion 110 includes a plurality of axially extending bores 120 formed therein. Each of the bores 120 is configured to receive a mechanical fastener 122 therein. The mechanical fasteners 122 are received into corresponding bores (not depicted) formed in the differential case 99 to couple the ring gear 108 to the differential case 99. More particularly, the bores formed in the differential case 99 may be threaded to secure the mechanical fasteners 122 therein. As such, the differential assembly 80 may be easily assembled and disassembled by inserting and removing the mechanical fasteners 122 as compared to a complicated assembly and disassembly procedure required by conventional designs.

As illustrated in FIG. 2, the ring gear 108 further includes an axially extending hub 126 having a bore 128 through which one of the output shafts extends. A second output bearing assembly 130 is operatively affixed within the output bore 32. The second output bearing assembly 130 includes an outer race 132 rigidly affixed to the housing 12 of the drive unit assembly 10, an inner race 134 affixed to and rotatable with the hub 126 of the ring gear 108, and a set of circumferentially spaced roller bearings 136 tapered generally outwardly from the differential gear assembly 84, i.e., having the larger diameter end portions nearest the differential gear assembly 84. A locking member 140 may be disposed into the output bore 32 of the housing 12 to secure the second output bearing assembly 130 therein.

In operation, a torque is transmitted from a power source to the drive unit assembly 10. The power source may be configured as an internal combustion engine that may be adapted to use or combust any suitable type of fuel, such as gasoline, diesel fuel, or hydrogen. Alternatively, multiple or different power sources may be provided, such as may be employed with a hybrid vehicle or electric vehicle. In such embodiments, the power source could be an electric power source, such as a battery, capacitor, or fuel cell, or a non-electric power source, such as a hydraulic power source.

The torque from the power source is transmitted to a drive pinion gear 60 of the drive unit assembly 10, causing a rotation of the input shaft 40 and the gear head 41. The rotation of the gear head 41 causes a rotation of the ring gear 108. The rotation of the ring gear 108 rotatably drives the differential case 99, and thus the differential gear assembly 80. The differential gear assembly 80 drives the output shafts and compensates for any differential rotation of the associated wheels.

In accordance with the provisions of the patent statutes, the present invention has been described to represent what is considered to represent the preferred embodiments. However, it should be noted that this invention can be practiced in other ways than those specifically illustrated and described without departing from the spirit or scope of this invention.

What is claimed is:

1.-8. (canceled)

9. A differential assembly, comprising:
a ring gear, wherein the ring gear includes:
a radially outer portion having an axial inner face configured to engage with a drive pinion gear; and
a radially inner portion including an annular flange portion having an inner face, wherein the annular flange portion does not extend axially past any portion of the axial inner face of the radially outer portion of the ring gear;
a differential case having an inner face configured to cooperate with the inner face of the annular flange portion of the ring gear, the differential case configured to receive a spider therein, wherein the spider includes a main body including a center bore formed therein.

10. The differential assembly of claim 9, wherein a portion of the spider is clamped between the ring gear and the differential case.

11. The differential assembly of claim 9, wherein the spider includes at least one leg portion radially outwardly extending from the main body.

12. The differential assembly of claim 9, wherein the ring gear and the differential case includes at least one generally semi-circular cross-bore formed therein.

13. The differential assembly of claim 12, wherein a portion of the spider is received into a throughbore formed by the cross-bores formed in the ring gear and the cross-bore formed in the differential case.

14. The differential assembly of claim 9, wherein the ring gear includes at least one axially extending bore formed therein.

15. The differential assembly of claim 14, wherein the ring gear is affixed to the differential case by at least one fastener received in the at least one axially extending bore.

16. A drive unit assembly for an axle, comprising:
a differential assembly including a ring gear, a differential case configured to cooperate with the ring gear, and a differential gear assembly at least partially disposed in the differential case, wherein the differential assembly is configured to receive a first axle shaft,
wherein the ring gear includes:
a radially outer portion having an axial inner face configured to engage with a drive pinion gear; and
a radially inner portion including an annular flange portion having an inner face, wherein the annular flange portion does not extend axially past any portion of the axial inner face of the radially outer portion of the ring gear;
wherein the differential gear assembly includes:
a spider clamped between the ring gear and the differential case, the spider including a main body having a center bore and a plurality of radially outwardly extending leg portions; and
a plurality of gears disposed within the differential case, wherein at least one of the gears is disposed on at least one of the leg portions of the spider.

17. The drive unit assembly of claim 16, wherein the differential assembly is configured to receive a second axle shaft.

18. The drive unit assembly of claim 17, wherein a length of the first axle shaft is substantially equal to a length of the second axle shaft.

19. The drive unit assembly of claim 17, wherein a length of the first axle shaft is different from a length of the second axle shaft.

20. (canceled)

21. (canceled)

22. The differential assembly of claim 9, wherein the radially outer portion of the ring gear surrounds at least a portion of the spider.

23. The drive unit assembly of claim 16, wherein the radially outer portion of the ring gear surrounds at least a portion of the spider.
